(19) United States
(12) Patent Application Publication
(10) Pub. No.: US 2015/0142368 A1
(43) Pub. Date: May 21, 2015

(54) Method for determining mechanical heat-up lag (MHL) of a building from the building's natural thermal lag (NTL)

(71) Applicant: Patrick Andrew SHIEL, Dublin (IE)

(72) Inventor: Patrick Andrew SHIEL, Dublin (IE)

(21) Appl. No.: 14/607,003

(22) Filed: Jan. 27, 2015

Related U.S. Application Data
(63) Continuation-in-part of application No. 13/906,822, filed on May 31, 2013, now Pat. No. 8,977,405.

(51) Int. Cl. G06Q 50/06

(52) U.S. Cl. CPC G06Q 50/06
USPC 702/136

(57) ABSTRACT

The invention provides an improved method for determining the mechanical heat-up lag of a building. The time lag for the heating system to reach its set point, which is referred to as the Mechanical Heat-up Lag (MHL) is dependent on the natural thermal lag (NTL) of a building. The invention provides a determination of the MHL as it relates to the NTL. The invention is very useful in reducing energy usage in commercial buildings when used in combination with a short term weather forecast.

### RELATED APPLICATIONS

This application is a continuation in part of U.S. application Ser. No. 13/906,822 by the same inventor, entitled Continuous Optimization Energy Reduction Process in Commercial Buildings, filed May 31, 2013, docket SHIEL002. The entirety of application Ser. No. 13/906,822 is incorporated by reference as if fully set forth herein.

This application is also related to U.S. applications with docket numbers SHIEL003 and SHIEL005, each by the same inventor and each a continuation in part of U.S. Ser. No. 13/906,822, and where the entireties of each of SHIEL003 and SHIEL005 are incorporated by reference as if fully set forth herein.

### GOVERNMENT FUNDING

None

### FIELD OF USE

The invention is useful in energy management, and more particularly in the field of energy management in commercial buildings.

### BACKGROUND

Energy use analysis in commercial buildings has been performed for many years by a number of software simulation tools which seek to predict the comfort levels of buildings while estimating the energy use. The underlying principles of these tools concentrate on the building itself and the desire to keep that building at a particular level of warmth and/or humidity.

Occupant comfort is assumed to be serviced based on generalized set of parameters and tables used by designers in specifying the building and plant within it. It has been shown over several years, that the predictive strength of these tools is not strong when comparing the design estimates of energy use with the reality, post-occupation.

### BRIEF SUMMARY OF THE INVENTION

The invention provides as improved method for determining a building's mechanical heat-up lag, which lag is unique to any given building. The improved method includes using the building's natural thermal lag (NTL), which lag is also unique to any given building. The invention provides information about optimal times to start the boiler or cooler of a commercial building, which are determined daily in light of the actual weather. Adjusting the start time of the heating or cooling plant provides for energy savings in the operation of the commercial building.

The MHL can be derived from recorded data over a full heating season. The length of time from the heating system start to the time required for the average internal space temperature to reach set point is referred to as the mechanical heat-up lag (MHL). The observation and recording of the MHL facilitates the derivation of a set of optimal times for the heating system to commence operation which are unique to any given building. The MHL is, empirically, dependent on average daily external temperature and the building fabric.

The MHL has an inverse relationship to the building's natural thermal lag (NTL). A linear regression relationship is derived which allows for the prediction of the MHL based solely on the building's NTL. The general form of this model is:

MHLᵢ=β₀−β₁NTLᵢ+εᵢ Eqn 1

where β₀ represents the intercept of the linear relationship on the y-axis. β₁ represents the slope of the relationship between MHL and NTL and ε represents the error inherent in the linear model.

For any given range of daily average external temperatures, for a known corresponding range of NTL values, a linear regression model is derived from which the MHL is forecast for the full heating season.

In the invention taught herein, the same calcuations are applied to data observed and recorded during a building's cooling season. During the cooling season, the length of time from commencement of the chiller and chiller pumps to the reaching of the set-point for the average internal space temperature is recorded and referred to as the mechanical cool down lag (MCL). This lag depends inversely on the building's NTL and therefore, with limited data, a model is derived relating the MCL to the NTL, in the form:

MCLᵢ=β₀−β₁NTLᵢ+εᵢ Eqn 2

where β₀ represents the intercept of the linear relationship on the y-axis. β₁ represents the slope of the relationship between MCL and NTL and ε represents the error inherent in the linear model.

### BRIEF DESCRIPTION OF THE DRAWINGS

The drawings listed are provided as an aid to understanding the invention:

FIG. 1 shows P1 average external temperature To (line) and the corresponding NTL values (dots) July 2012 to August 2013 with polynomial trendlines

FIG. 2 shows Forecasted MHL vs actual NTL plots from July 2012 to August 2013 including both heating and cooling seasons

FIG. 3 shows Observed versus forecast mechanical het-up (MHL) lags values for P1 building heating season from mid-September 2012 to mid-April 2013 with fitted 3rd order polynomial regression lines. The NTL values and fitted regression line is shown for reference

### DETAILED DESCRIPTION OF A PREFERRED EMBODIMENT

Introduction

In SHIEL002 (U.S. application 13/906,822 incorporated by reference as if fully set forth herein), a method to derive a building's natural thermal lag (NTL) was presented. Ther present invention takes into account the amount of time required for the heating system installed in a commercial building as a function of external temperature. It is of interest to determine if there exists a causal link between the length of time required for the building-wide heating system to reach operating temperature (or set point) and the building's NTL. To determine if the heating system has reached set point, a typical space temperature is monitored and once this reaches a temperature deemed appropriate for occupant comfort, the heating system is deemed to have reached set point.

In SHIEL002, the NTL was determined by comparing internal space temperature and the corresponding external temperature during a period of time when the building is at rest with no mechanical heat or cooling, little or no solar gain and little or no occupant activity. The NTL is indicative of how quickly the internal space temperature of a building is affected by heat loss or heat gain from the external environment. The length of time required for the building's heating system to reach set point depends in part on the external temperature. Assuming the heating system is off overnight, while the building is unoccupied, the external temperature experienced by the building during the late night and early morning will affect the amount of time required to reach the desired set point. In this invention, given that the analysis pertains to the time lag for the heating system to reach its set point, it has been referred to as the Mechanical Heat-up Lag (MHL). The invention teaches that the MHL in a building is dependent upon the NTL and therefore if the NTL variation is known for the heating season, the MHL can be shown to be dependent on the inverse of the NTL.

It is possible to determine the MHL without a full season's heating data. Because the MHL is directly proportional to the inverse of the NTL, only a few reference values of the MHL are required to establish the relationship with the NTL, the slope of the MHL curve will follow the inverse of the NTL, and therefore, the MHL can be fully and accurately extrapolated from the NTL over the heating season.

This is very useful in reducing energy usage in commercial buildings when used in combination with a short term weather forecast. Once the overnight external temperature profile is known, then the optimum start up time for the boilers can be easily determined, and start up times adjusted on a day to day basis. It can be appreciated that adjusting the start up time of a building's boiler by using the MHL of the building according to the invention is in contrast with the conventional method used to start up heating systems, which is normally based on a simple time clock and for the winter may start at the same time every day. Because the boilers do not need to start operation at this set time, the energy savings in delaying that start time are substantial.

Natural Thermal Lag

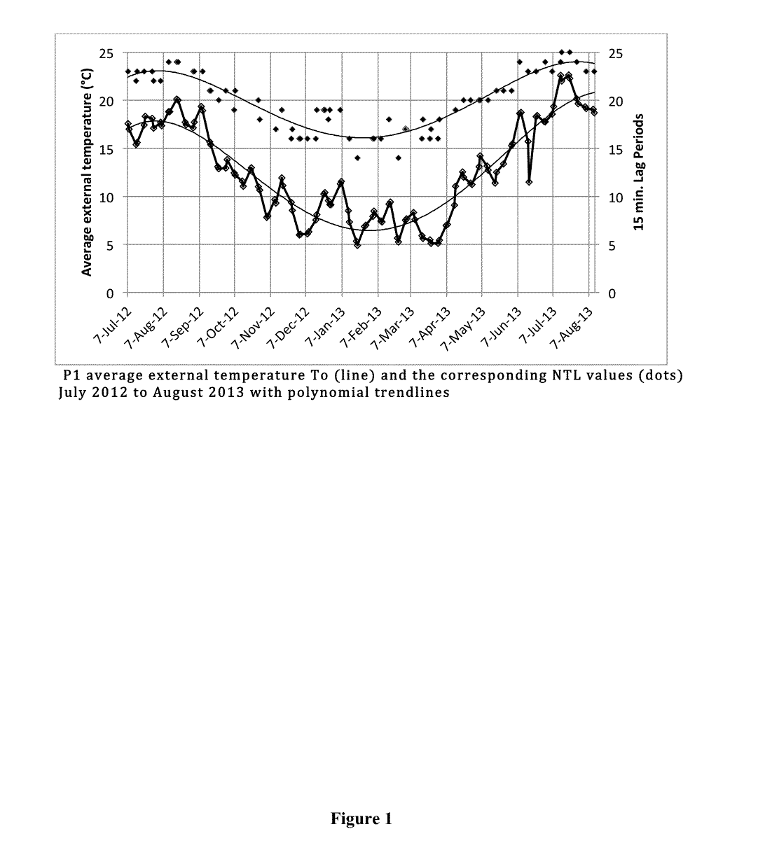

From SHIEL002, the natural thermal lag can be derived from year-long 15-minute interval data for both internal space and external temperatures. The example shown in FIG. 1 shows the variation of NTL with the changing external temperature over a full year. From FIG. 1, it is evident that as average daily external temperature varies, the NTL value for any given external temperature approximately follows the same sinusoidal pattern.

Mechanical Heat-Up Lag

Examining the internal space temperature data from the P1 building at boiler start-up time, it is evident that the mechanical heat-up lag (MHL), as with the NTL, also varies with average daily external temperature. By use of the common practice of single linear regression, an approximate relationship between any value of MHLᵢ and NTLᵢ is formed as follows:

MHLᵢ=β₀−β₁NTLᵢ+εᵢ Eqn 1

where β₀ represents the intercept of the linear relationship on the y-axis. β₁ represents the slope of the relationship between MHL and NTL and ε represents the error inherent in the linear model.

This value of MHL for any given daily average external temperature provides sufficient information to facilitate guidance on how long it takes for the building to reach the desired or specified internal space temperature.

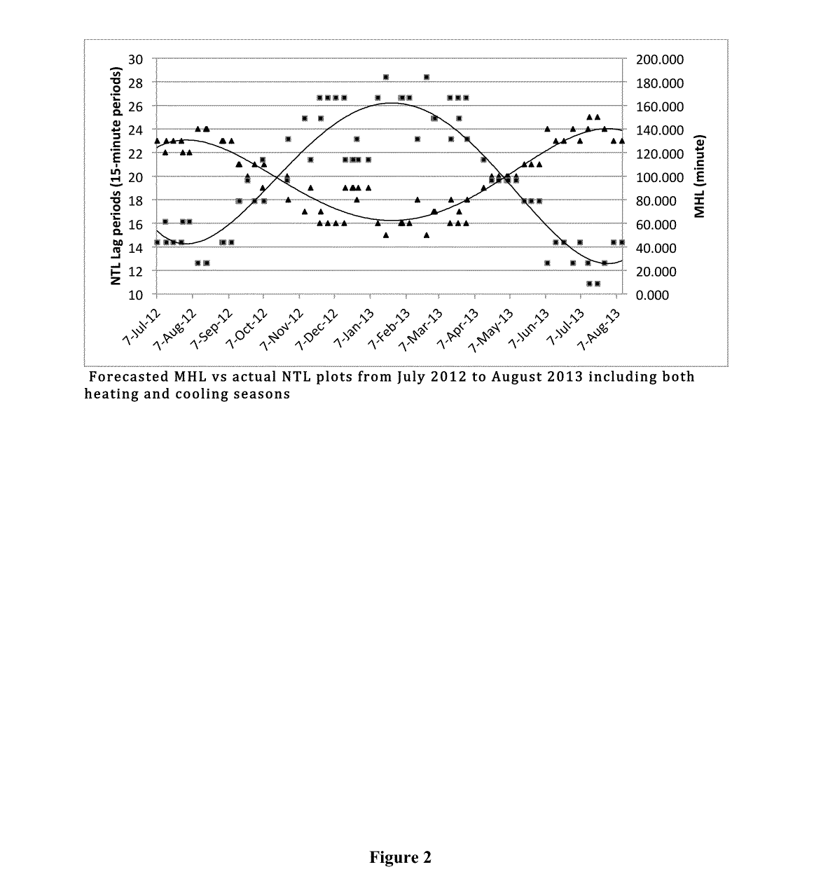

The result of this MHL forecast is shown in FIG. 2 and shows accuracy with those MHL values measured over the heating season.

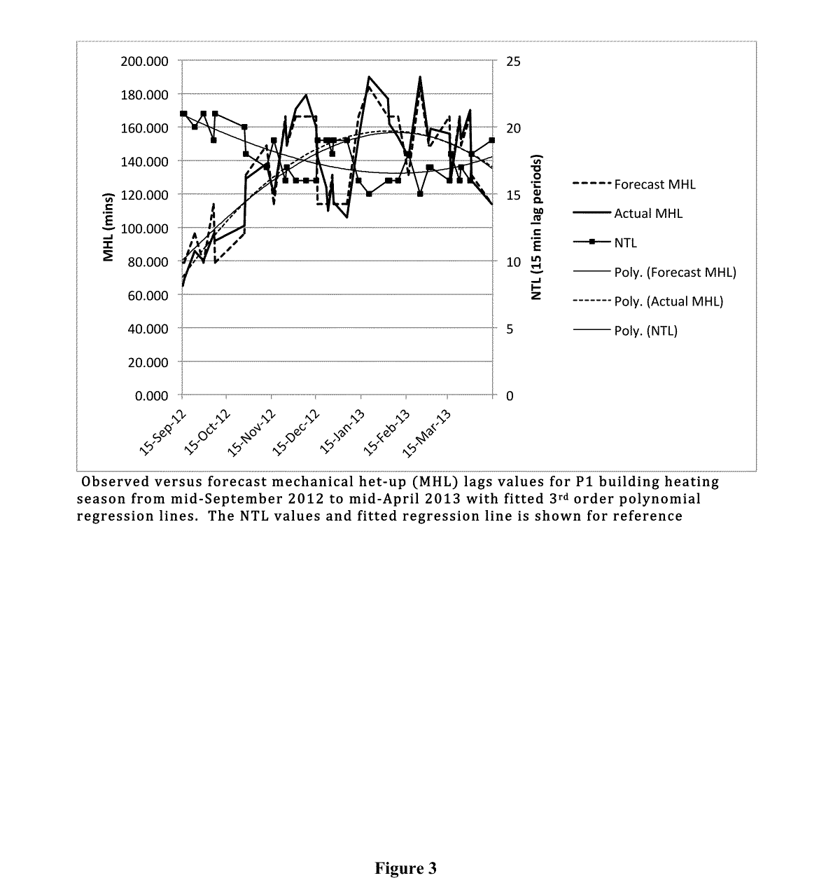

The linear model forecast predicts the mechanical heat up period varies from approximately 30 minutes in summer to over 160 minutes in winter. Heating is off in summer, but the actual observed MHL figures closely resemble the forecast for the winter period and are shown in FIG. 3. The polynomial regression lines for both observed and forecast MHL responses curves are shown to closely correlate.

Since the NTL and MHL are both derived parameters, based on data measured in the actual building during actual operation, they both are indicative of the real world heating energy performance, uniquely, for a particular building.

An identical analysis can be carried out for the cooling season.

Minimizing the Data Requirements

It has been observed with several building data examinations and shown in the previous section's example, that because the MHL depends in large part on the NTL for any given average daily external temperature, is predictable the MHL from the NTL alone once a few reference points are formed. This can be achieved with one week of observed MHL data. Such observed data facilitates the prediction of the optimum start up time for the building's heating system based on forecast average daily external temperatures alone.

What is claimed is:

1. An improved method of determining the mechanical heat-up lag of a building, wherein the improvement comprises the step of predicting the mechanical heat-up lag of a building based on the natural thermal lag of said building, according to the equation
MHLᵢ=β₀−β₁NTLᵢ+εᵢ Eqn 1
where β₀ represents the intercept of the linear relationship on the y-axis, β₁ represents the slope of the relationship between MHL and NTL, and ε represents the error inherent in the linear model.

2. An improved method of determining mechanical cool-down lag of a building, wherein the improvement comprises the step of predicting the mechanical cool-down lag of a building base on the natural themal lag of said building according to the equation
MCLᵢ=β₀−β₁NTLᵢ+εᵢ Eqn 2
where β₀ represents the intercept of the linear relationship on the y-axis, β₁ represents the slope of the relationship between MCL and NTL, and εrepresents the error inherent in the linear model.
